(19) United States
(12) Patent Application Publication
(10) Pub. No.: US 2025/0134764 A1
(43) Pub. Date: May 1, 2025

(54) PORTABLE CARDIAC MASSAGE APPARATUS

(71) Applicant: Michael Dennis Doeve, Den Haag (NL)

(72) Inventor: Michael Dennis Doeve, Den Haag (NL)

(21) Appl. No.: 18/693,807

(22) PCT Filed: Oct. 5, 2022
(86) PCT No.: PCT/EP2022/077622

§ 371 Date: Mar. 20, 2024

(30) Foreign Application Priority Data
Oct. 5, 2021 (EP) 21200899.9

(51) Int. Cl. A61H 31/00

(52) U.S. Cl. CPC A61H 31/007; A61H 2201/1253; A61H 2201/1635; A61H 2201/1664; A61H 2201/1676; A61H 2203/0456

(57) ABSTRACT

A portable cardiac massage apparatus comprises a C-shaped frame including a base, an upper arm and an upright body, a plunger for applying pressure to a patient's sternum, which plunger is coupled to and movable with respect the upper arm toward the base and back. A lever is pivotally coupled to the plunger through a first hinge and to a link rod through a second hinge. The link rod is pivotally coupled to the upper arm through a third hinge. The lever is also pivotally connected to an auxiliary rod through a fourth hinge. The auxiliary rod is pivotally connected to the upright body through a fifth hinge that is displaceable along the upright body in toward the base and back. The first hinge is located between the second and fourth hinges and beyond the fourth hinge as seen in a direction from the upright body to the plunger.

### CROSS-REFERENCE TO RELATED APPLICATION(S)

This application is a Section 371 National Stage Application of International Application No. PCT/EP2022/077622, filed Oct. 5, 2022 and published as WO 2023/057473 A1 on Apr. 13, 2023, in English.

### BACKGROUND

The present invention relates to a portable cardiac massage apparatus, comprising a C-shaped frame including a base for positioning under the back of a supine patient, an upper arm and an upright body which interconnects the base and the upper arm, a plunger for applying pressure to the sternum of a patient lying on the base, which plunger is coupled to the upper arm and movable with respect to the upper arm in a direction from the upper arm to the base and back and a lever for operating the plunger which lever is pivotally coupled to the plunger through a first hinge and to a link rod through a second hinge located at a distance from the first hinge, wherein the link rod is pivotally coupled to the upper arm through a third hinge located at a distance from the second hinge.

Such an apparatus, which is also called a resuscitation device, is known from U.S. Pat. No. 3,425,409. It is used in cases of cardiac arrest to maintain the blood circulation in a patient. It consists of the application of periodic downward force on the sternum of the patient. Depression of the sternum compresses the heart and forces blood into the arteries, the chest expanding and the heart filling with oxygenated blood when the pressure on the sternum is released. The cycle is repeated, for example up to 100 times per minute. Cardiac massage can be performed manually by a suitable trained operator, but it is extremely fatiguing to the lifesaver. The known apparatus can be operated by one person for long periods of time without undue fatigue. It has a plunger which is raised and lowered by the lever to compress the chest of the patient.

An object of the invention is to provide an improved portable cardiac massage apparatus.

### SUMMARY

This object is accomplished with the apparatus according to the invention which is characterized in that the lever is also pivotally connected to an auxiliary rod through a fourth hinge located at a distance from the first and second hinges, wherein the auxiliary rod is pivotally connected to the upright body through a fifth hinge that is displaceable along the upright body through a guide at the upright body in a direction from the upper arm to the base and back, wherein the first hinge is located between the second and fourth hinges and beyond the fourth hinge as seen in a direction from the upright body to the plunger.

An advantage of the present invention is that the auxiliary rod provides a robust structure to the apparatus due to its additional support of the lever.

The third hinge may be located beyond the plunger as seen in a direction from the upright body to the plunger.

In a preferred embodiment the auxiliary rod is provided with a foot support including an upper surface for receiving a foot so as to operate the plunger by means of foot pressure. This is less fatiguing to a lifesaver.

The foot support may be located at a lower end of the auxiliary rod remote from the fourth hinge.

In a practical embodiment the foot support is formed by a projection on the auxiliary rod which projection extends in transverse direction of the auxiliary rod.

The upright body and the auxiliary rod may be provided with a stop mechanism for limiting the maximum displacement of the fifth hinge in upward direction along the upright body. This means that the maximum height of the plunger is also dictated by the stop mechanism.

Preferably, the stop mechanism is adjustable so as to vary the maximum displacement, since it provides the opportunity to apply the apparatus for patients having different body sizes.

The stop mechanism may comprise a first stop element which is located at the upright body and a cooperating second stop element which is located at the auxiliary rod, which first and second stop elements contact each other upon reaching the maximum displacement.

The position of the first stop element may be adjustable in longitudinal direction of the upright body so as to vary the maximum displacement.

In a particular embodiment the first stop element is displaceable along the guide. It may be releasably attachable to the guide.

In an embodiment the lever is extendable in its longitudinal direction, wherein an extendable part comprises a handle for moving the lever up and down. When the apparatus is not used the extendable part can be retracted to facilitate transporting of the apparatus.

The apparatus may be provided with a return spring which is fixed to the upright body and to the auxiliary rod, wherein the return spring is adapted such that its spring force is larger in a lower position of the lever than in a higher position of the lever. This means that the spring urges the lever in upward direction after a downward displacement of the lever.

The base, the upright body and the upper arm may be made from one piece in order to provide a rigid structure.

### BRIEF DESCRIPTION OF THE DRAWINGS

The invention will hereafter be elucidated with reference to very schematic drawings showing an embodiment of the invention by way of example.

FIG. 1 is a perspective view of an embodiment of a portable cardiac massage apparatus.

FIG. 2 is a side view of the embodiment as shown in FIG. 1.

FIG. 3 is a similar view as FIG. 2, but showing the apparatus in a different condition on a larger scale.

FIG. 4 is an enlarged view along the line IV-IV in FIG. 2, showing a part of the apparatus.

FIG. 5 is a similar view as FIG. 4, but showing the part in a different condition.

FIG. 6 is an enlarged view along the line VI-VI in FIG. 2.

### DETAILED DESCRIPTION OF THE ILLUSTRATIVE EMBODIMENT

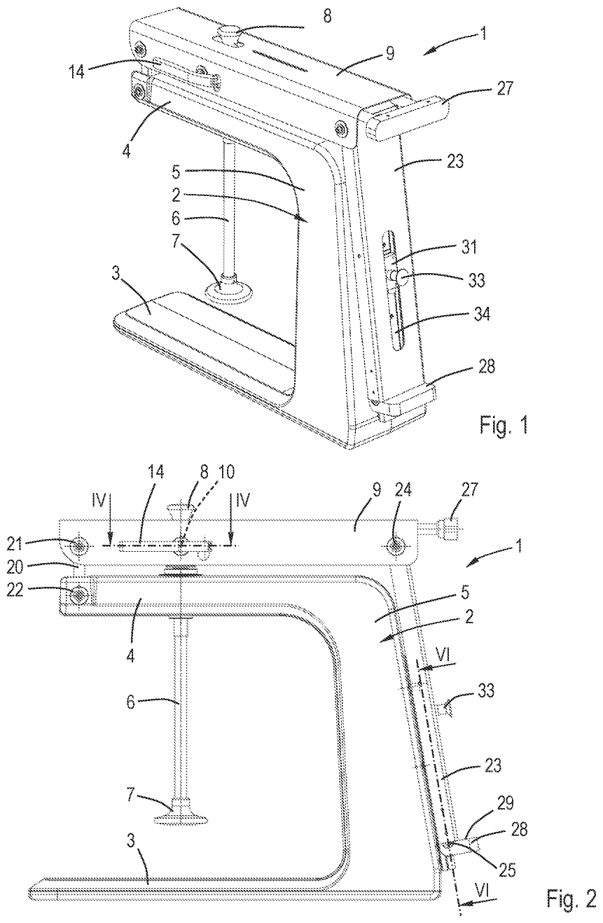

FIGS. 1-6 show different views and parts of an embodiment of a portable cardiac massage apparatus 1. The apparatus 1 comprises a C-shaped frame 2 which has a base in the form of a base plate 3, an upper arm 4 and an upright body 5. The upright body 5 interconnects the base plate 3 and the upper arm 4. In this case the base plate 3, the upright body 5 and the upper arm 4 are made from one piece, i.e. integrally formed, but they may also be separate parts which are fixed to each other. The base plate 3 is suitable for positioning under the back of a supine patient and has bevelled edges to facilitate sliding of the base plate 3 under the back of the patient. The C-shaped frame 2 as shown in the drawings appears to be a rigid structure, although it is noted that many alternative shapes and dimensions of the base plate 3, the upper arm 4 and the upright body 5 are conceivable.

The upper arm 4 and the base plate 3 extend in respective substantially parallel planes. The space between the upper arm 4, the upright body 5 and the base plate 3 can accommodate the torso of a patient.

The apparatus 1 is provided with an oblong plunger 6 which has a centreline that extends in a direction from the base plate 3 to the upper arm 4, i.e. in transverse direction of the planes within which the upper arm 4 and the base plate 3 extend.

A lower end of the plunger 6 has a disc-shaped pushing element 7 which can be positioned onto the sternum of a patient lying on the base plate 3. An upper end of the plunger 6 is provided with a knob 8.

The plunger 6 is coupled to the upper arm 4 and movable with respect to the upper arm 4 along its centreline in a direction from the upper arm 4 to the base plate 3 and back.

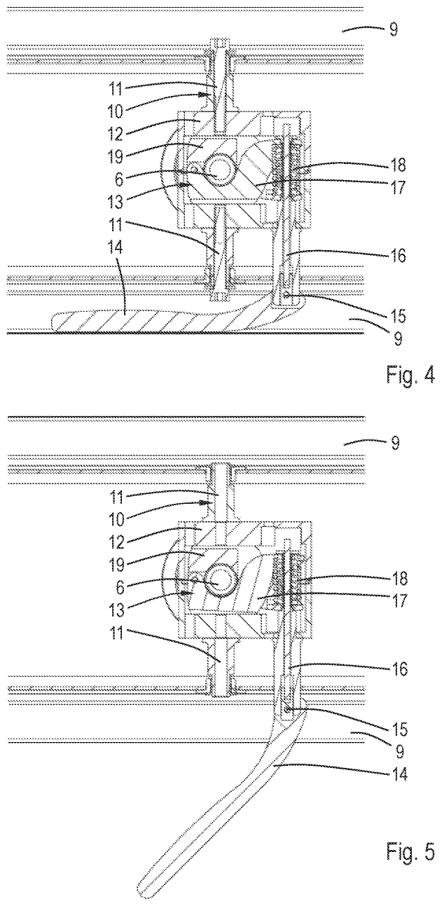

Furthermore, the apparatus 1 has a lever 9 for operating the plunger 6. The lever 9 is pivotally coupled to the plunger 6 through a first hinge 10, see FIGS. 4 and 5. The first hinge 10 has a centreline which extends transversely to a plane which is spanned by the C-shaped frame 2. The first hinge 10 comprises two pins 11 which are mounted to opposite sides of a housing 12. The housing 12 is releasably fixed to the plunger 6 through a clamping mechanism 13 and pivotable with respect to the lever 9 through the pins 11.

The clamping mechanism 13 has a clamping mechanism handle 14 including a pin 15, which clamping mechanism handle 14 is rotatably coupled to a clamping mechanism rod 16. The clamping mechanism rod 16 is mounted to a rotatable clamping brace 17, such that when the clamping mechanism handle 14 is turned away from the housing 12, the pin 15 moves away from the housing 12 causing the clamping mechanism rod 16 in a direction away from the housing 12 and moving the clamping brace 17 away from the plunger 6 against a spring force of a spring 18. This allows the plunger 6 to be moved with respect to the housing 12 in the longitudinal direction of the plunger 6. When moving the clamping mechanism handle 14 back towards the housing 12, the spring 18 forces the clamping brace 17 against the plunger 6 such that the latter obtains a fixed position with respect to the housing 12. This situation is illustrated in FIG. 4. In this condition the plunger 6 is clamped between the clamping brace 17 and a counter clamping brace 19 which is fixed to the housing 12. The clamping mechanism handle 14 provides the opportunity to quickly adjust the position of the plunger 6 with respect to the upper arm 4 by turning the clamping mechanism handle 14 by one hand and displacing the plunger 6 by the other hand. For a convenient grip the knob 8 is provided at the top of the plunger 6.

It is important that the plunger 6 can be moved with respect to the housing 12 since the apparatus 1 will be used for different persons which means that the distance between the upper arm 4 and the sternum of patients will vary from person to person.

The apparatus 1 is also provided with a link rod 20 of which one end is pivotally coupled to the lever 9 through a second hinge 21 located at a distance from the first hinge 10 and of which an opposite end is pivotally coupled to the upper arm 4 through a third hinge 22 located at a distance from the second hinge 21.

The lever 9 is also pivotally connected to an auxiliary rod 23 through a fourth hinge 24, which is located at a distance from the first and second hinges 10, 21. The first hinge 10 is located between the second hinge 21 and the fourth hinge 24. Furthermore, the first hinge 10 is located beyond the fourth hinge 24 as seen in a direction from the upright body 5 to the plunger 6. The auxiliary rod 23 is pivotally connected to the upright body 5 through a fifth hinge 25. The upright body 5 is provided with a guide 26 along which the fifth hinge 25 is slidable in a direction from the upper arm 4 to the base plate 3 and back.

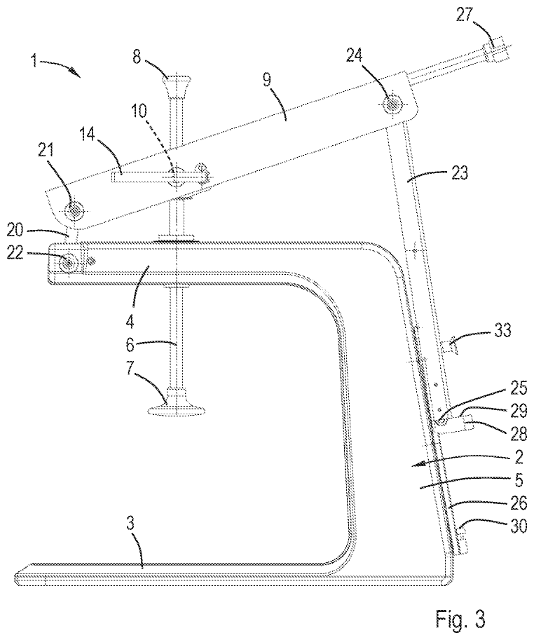

The lever 9 has an extendable part including a handle 27 for moving the lever 9 up and down, i.e. for manually operating the plunger 6. FIG. 2 shows a transport condition of the apparatus 1 in which the extendable part is retracted and FIG. 3 shows an operable condition in which the extendable part is extended.

The auxiliary rod 23 is also provided with a foot support 28 including an upper surface 29 for receiving a foot so as to operate the plunger 6 by means of foot pressure. The foot support 28 is located at a lower end of the auxiliary rod 23 remote from the fourth hinge 24. In this case the foot support 28 is formed by a projection on the auxiliary rod 23 which projection extends in transverse direction of the auxiliary rod 23, but alternative configurations are conceivable.

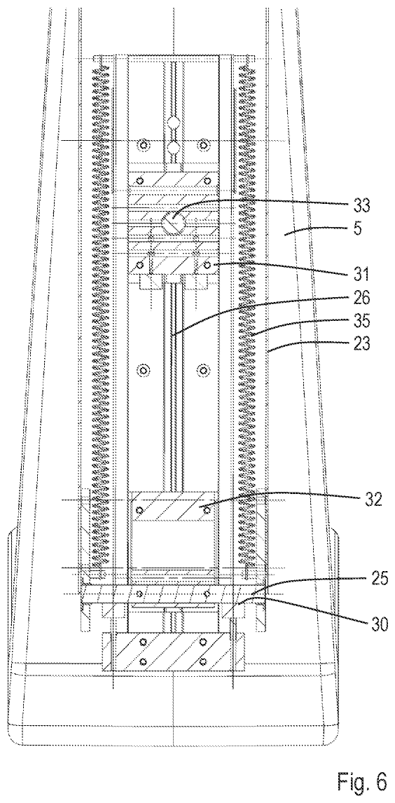

In the operable condition of the apparatus 1 the plunger 6 is movable between a highest position and a lowest position with respect to the upper arm 4 in order to create a well-defined pressure profile onto the chest of a patient. These positions are illustrated in FIGS. 3 and 2, respectively. The lowest position is defined by a lower stop 30, see FIGS. 3 and 6. The highest position of the plunger 6 with respect to the upper arm 4 is defined by a stop mechanism for limiting the maximum displacement of the fifth hinge 25 in upward direction along the upright body 5. The stop mechanism is provided at the upright body 5 and the auxiliary rod 23. In this case the stop mechanism comprises a first stop element 31 located at the upright body 5 and a second stop element 32 located at the auxiliary rod 23. The first stop element 31 is displaceable along the guide 26 at the upright body 5 and can be releasably fixed to the guide 26 at different height levels along the guide 26 by means of a rotary knob 33 in order to vary the maximum displacement of the auxiliary rod 23 in upward direction. The second stop element 32 is movable along the guide 26 together with the fifth hinge 25. When moving upwardly the second stop element 32 will contact the first stop element 31 at the end of the movement.

FIG. 1 shows that the rotary knob 33 passes through an elongate slot 34 in the auxiliary rod 23 such that a lifesaver can easily reach it so as to operate the first stop element 31 from outside. The rotary knob 33 and the slot 34 are adapted such that the rotary knob 33 is displaced with respect to the slot 34 within the slot 34 in longitudinal direction thereof when moving the lever 9 up and down.

FIG. 6 shows that the apparatus 1 comprises two parallel return springs 35. Upper ends of the return springs 35 are fixed to the upright body 5 and lower ends of the return springs 35 are fixed to the auxiliary rod 23. In an upper position of the lever 9, as shown in FIG. 3, the spring forces of the respective return springs 35 are lower than in a lower position of the lever 9, as shown in FIG. 2. After moving down the lever 9 it will automatically return upwardly due to the spring forces.

In practice, after positioning the base plate 3 under the back of a patient the lifesaver can adjust the position of the plunger 6 at a desired height level by means of the clamping mechanism handle 14 in order to define the lowest position of the plunger 6. The plunger 6 is then secured in position by the clamping mechanism handle 14. Furthermore, the stop element 31 can be set in order to define the highest position of the plunger 6. Subsequently, the chest compressions can be started by forcing the lever 9 down and raising it up at a predefined frequency, either manually by means of the handle 27 or by foot pressure by means of the foot support 28.

The invention is not limited to the embodiment shown in the drawings and described hereinbefore, which may be varied in different manners within the scope of the claims and their technical equivalents.

1. A portable cardiac massage apparatus, comprising:
a C-shaped frame including a base for positioning under a back of a supine patient;
an upper arm;
an upright body which interconnects the base and the upper arm;
a plunger configured to apply pressure to a sternum of a patient lying on the base, which plunger is coupled to the upper arm and movable with respect to the upper arm in a direction from the upper arm to the base and back;
a link rod;
an auxiliary rod; and
a lever pivotally coupled to the plunger through a first hinge and to the link rod through a second hinge located at a distance from the first hinge, wherein the link rod is pivotally coupled to the upper arm through a third hinge located at a distance from the second hinge,
wherein the lever is also pivotally connected to the auxiliary rod through a fourth hinge located at a second distance from the first and second hinges, wherein the auxiliary rod is pivotally connected to the upright body through a fifth hinge that is displaceable along the upright body through a guide at the upright body in a direction from the upper arm to the base and back, wherein the first hinge is located between the second and fourth hinges and beyond the fourth hinge as seen in a second direction from the upright body to the plunger.

2. The portable cardiac massage apparatus according to claim 1, wherein the auxiliary rod is provided with a foot support including an upper surface configured to receive a foot so as to operate the plunger by foot pressure.

3. The portable cardiac massage apparatus according to claim 2, wherein the foot support is located at a lower end of the auxiliary rod remote from the fourth hinge.

4. The portable cardiac massage apparatus according to claim 2, wherein the foot support is formed by a projection on the auxiliary rod which projection extends in a transverse direction of the auxiliary rod.

5. The portable cardiac massage apparatus according to claim 1, wherein the upright body and the auxiliary rod are provided with a stop mechanism configured to limit a maximum displacement of the fifth hinge in an upward direction along the upright body.

6. The portable cardiac massage apparatus according to claim 5, wherein the stop mechanism is adjustable so as to vary the maximum displacement.

7. The portable cardiac massage apparatus according to claim 5, wherein the stop mechanism comprises a first stop element located at the upright body and a cooperating second stop element located at the auxiliary rod, which first and second stop elements contact each other upon reaching the maximum displacement.

8. The portable cardiac massage apparatus according to claim 7, wherein a position of the first stop element is adjustable in a longitudinal direction of the upright body so as to vary the maximum displacement.

9. The portable cardiac massage apparatus according to claim 8, wherein the first stop element is displaceable along the guide.

10. The portable cardiac massage apparatus according to claim 1, wherein the lever is extendable in its longitudinal direction, wherein an extendable part comprises a handle configured to move the lever up and down.

11. The portable cardiac massage apparatus according to claim 1 further comprising a return spring which is fixed to the upright body and the auxiliary rod, wherein the return spring is configured such that its spring force is larger in a lower position of the lever than in a higher position of the lever.

12. The portable cardiac massage apparatus according to claim 1, wherein the base, the upright body and the upper arm are made from one piece.

13. The portable cardiac massage apparatus according to claim 3, wherein the foot support is formed by a projection on the auxiliary rod which projection extends in a transverse direction of the auxiliary rod.

14. The portable cardiac massage apparatus according to claim 6, wherein the stop mechanism comprises a first stop element located at the upright body and a cooperating second stop element located at the auxiliary rod, which first and second stop elements contact each other upon reaching the maximum displacement.
